(19) United States
(12) Patent Application Publication
(10) Pub. No.: US 2010/0082609 A1
(43) Pub. Date: Apr. 1, 2010

(54) SYSTEM AND METHOD FOR BLENDING USER RANKINGS FOR AN OUTPUT DISPLAY

(75) Inventors: Gordon Sun, Redwood Shores, CA (US); Zhaohui Zheng, Sunnyvale, CA (US); Hongyuan Zha, Norcross, GA (US)

Correspondence Address: YAHOO! INC.;C/O Ostrow Kaufman & Frankl LLP, The Chrysler Building, 405 Lexington Avenue, 62nd Floor, NEW YORK, NY, 10174, US

(73) Assignee: YAHOO! Inc., Sunnyvale, CA (US)

(21) Appl. No.: 12/242,301

(22) Filed: Sep. 30, 2008

(51) Int. Cl. G06F 17/30

(52) U.S. Cl. 707/723; 707/E17.017

(57) ABSTRACT

A method and system for blending ranking for an output display includes receiving a first list of content items having a first ranking determined by first ranking parameters, the first ranking providing for a sequential ordering of the content items of the first list. A second list of content items having a second ranking determined by second ranking parameters are received, the first ranking is incompatible with the second ranking because ranking parameters are different. The first list of content items is transformed to a modified first list that maintains the order of the content items and makes the first ranking of the modified first list compatible with the second ranking of the second list. The second list and the modified first list are merged to generate a blended list for an output display utilizing the blended list.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF INVENTION

The present invention relates generally to search results and more specifically to the blending of rankings of different result sets from different verticals.

### BACKGROUND OF THE INVENTION

One metric of search engine effectiveness is the search results. There is an ever increasing growth in all aspects of search engine technology. For example, there is a growth to better understand the user's intent when conducting a search operation, there is a growth to improve the accuracy of advertisements placed with search results and there is a growth to provide improved search results.

There are many different areas, or verticals, in which a search engine may perform search operations. Search results are processed and ranked according to ranking algorithms known to the particular vertical. Problems exist when a single search engine receives search results from these different verticals because of the different rankings within each vertical.

A typical resultant operation of a search engine is the generation of a search results display. When searching is done from a single vertical, the resultant display consists of visual manipulation of the search results for the placement on the output display. The rankings are typically undisturbed, except for paid content. The rankings may include ranking of content found as a result of the search operation and the rankings may also include paid inclusion items, also known as advertising, placed in the search results. It is common for search results to include one or more paid inclusion items added into the ranking results, often selected based on the user-entered search term(s).

When searching is done across multiple verticals, the verticals themselves rank the content items according to their own ranking parameters. Therefore, existing search engine technology is limited to one of several options. A first option is to only search in a single vertical, limiting the search engine itself. A second option is to search in multiple verticals, but then differentiate the search result page(s) by explicitly showing the distinct search results from the distinct verticals. This second option is not ideal because it requires the user to examine multiple result sets. Furthermore, it buries highly relevant search results for all verticals not listed first because the ranking of the first vertical pushes the other verticals further down in the search results display. Additionally, it limits the display of ranking items because to accommodate multiple verticals, the typical display only shows the first several displays of each vertical. Also, the separate listing of multiple verticals can produce redundant search results where for search results may be listed in different verticals.

As such, there exists a need for a method and system to blend rankings from a plurality of verticals for generating an output display that includes the blended rankings.

### SUMMARY OF THE INVENTION

A method and system for blending ranking for an output display includes receiving a first list of content items having a first ranking determined by first ranking parameters, the first ranking providing for a sequential ordering of the content items of the first list. The method and system includes receiving a second list of content items having a second ranking determined by second ranking parameters, the second ranking providing for a sequential ordering of the content items of the second list, wherein the first ranking of the first list is incompatible with the second ranking of the second list because the first ranking parameters are different from the second ranking parameters. The method and system includes transforming the first list of content items to a modified first list, the order of the content items from the first list being maintained in the modified first list, wherein the transforming makes the first ranking of the modified first list compatible with the second ranking of the second list. The method and system includes merging the second list and the modified first list to generate a blended list and generating the output display utilizing the blended list.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of one embodiment of a system for blending ranking for an output display;

FIG. 2 illustrates a block diagram of representative rankings from different verticals;

FIG. 3 illustrates a flowchart of the steps of one embodiment of a method for blending ranking for an output display; and

FIG. 4 illustrates a sample screen shot of an output display that includes blended rankings in accordance with one embodiment of the present invention.

### DETAILED DESCRIPTION OF THE EMBODIMENTS

In the following description, reference is made to the accompanying drawings that form a part hereof, and in which is shown by way of illustration specific embodiments in which the invention may be practiced. It is to be understood that other embodiments may be utilized and structural changes may be made without departing from the scope of the present invention.

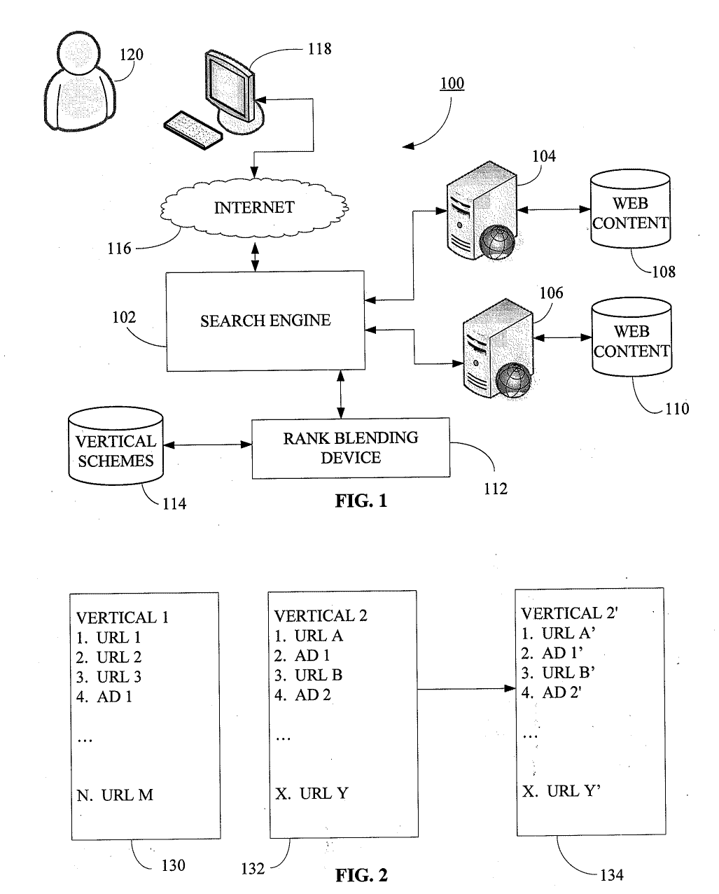

FIG. 1 illustrates a system 100 that includes a search engine 102, searching verticals 104, 106, each vertical having content databases 108, 110, respectively. The system 100 includes a rank blending device 112 and a vertical scheme database 114, as well as a network connection 116, user computer 118 and user 120.

The search engine 102 may be any suitable type of search engine device in accordance with known search engine technology as recognized by one skilled in the art, the search engine 102 additionally including functionality as described in further detail below. The searching verticals 104 and 106 may be any suitable type of vertical processing system allowing for searching activities within the vertical itself, wherein the servers 104 and 106 may be interfacing and data access points for the content databases 108 and 110. As described in further detail below, the searching verticals 104 and 106 include vertical-specific ranking protocols or techniques.

The rank blending device 112 may be one or more processing devices operative to perform rank blending operations as described in further detail below. The database 114 may be one or more data storage devices operative to store vertical scheme information therein.

The system 100 may include operations consistent with existing searching techniques, such as the user 120, via the computer 118, accessing the search engine to perform a search operation. The search engine 102 may also perform searching on the different verticals 104 and 106 in accordance with known techniques, including directly accessing each vertical to perform search operations. The search operations may be performed in accordance with known techniques, such that each vertical 104, 106 is accessed and separate search results are returned.

FIG. 2 illustrates two representative illustrations of vertical-specific search results. A first vertical result 130 relates to vertical 1, which may be the vertical 104 and content database 108. A second vertical result 132 relates to vertical 2, which may be the vertical 106 and content database 110.

The exemplary results 130, 132 include a list of uniform resource locators (URLs) and also include paid inclusion items, e.g. advertisements. The vertical search results are typically the resultant feature of vertical-specific search as well as the application of vertical specific rankings, based on vertical specific ranking parameters. It is recognized that generation of the vertical-specific results 130 and 132 may be performed using known generation techniques recognized by one skilled in the art.

From this vertical-specific search result, the rank blending device 112 is operative to generate the modified vertical ranking usable for blending. Illustrated in FIG. 2, the second vertical 132 is then transformed into the vertical two prime listing 134, the transformation described in further detail below. FIG. 2 illustrates the monotonic transformation wherein the ordering or sequence of content items is maintained between original list 132 and transformed list 134. Using this transformed search result listing, the different verticals may then be blended.

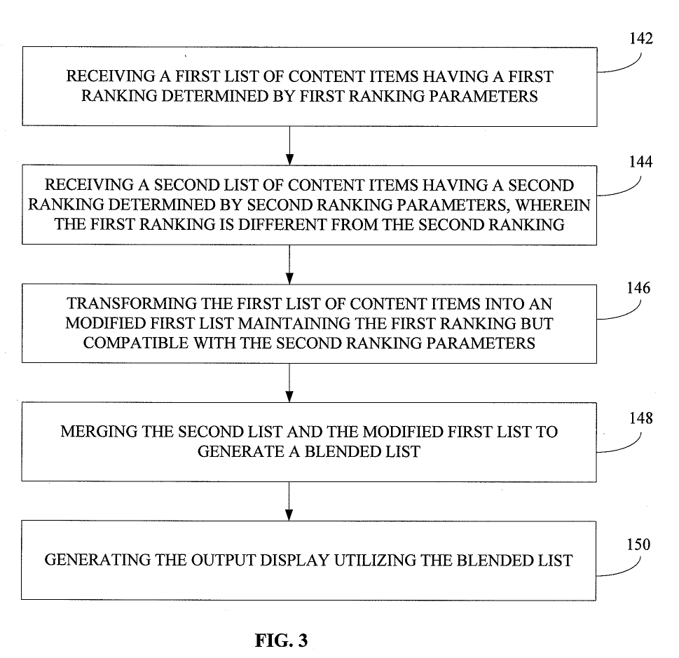

FIG. 3 illustrates a flowchart of the steps of one embodiment of a method for blending rankings for an output display. For brevity and clarification, the steps of the flowchart of FIG. 3 are described relative to the exemplary system 100 of FIG. 1. It is also recognized that the processing operations of the methodology of FIG. 3 may be performed by the rank blending device 112 in response to executable instructions from a computer readable medium. The rank blending device 112 may be disposed within the search engine 102 or can be a separate processing device, as illustrated in FIG. 1.

In the method, a first step, step 142, includes receiving a first list of content items having a first ranking determined by first ranking parameters. The first ranking provides for a sequential ordering of the content items of the first list. The first list may be list 130, received from the search engine 102, after the search engine 102 receives the list from the first vertical 104. By way of example, the first vertical v1 may have content as its input (for example query-url pairs) and apply scoring/ranking functions to generate s1( ). The ranking of the vertical content includes sorting the content based on the applicable scores.

The next step, step 144, includes receiving a second list of content items having a second ranking determined by second ranking parameters, wherein the first ranking is different from the second ranking. This second list may be the list 132 received by the rank blending device 112 via the search engine 102 from the second vertical 106. The second vertical v2 may apply scoring/ranking functions to generate s2( ). Again, the ranking of the vertical content includes sorting based on the scores.

The second list of content items is incompatible with the first list of content items because of differences in ranking parameters. These differences are borne out by the different verticals and hence the different generation of s1( ) and s2( ), as recognized by one skilled in the art.

A next step, step 146, is transforming the first list of content items into a modified first list, the ranking of the content of the modified first list is compatible. To clarify, FIG. 2 illustrates the transformation of the second list of content items, but it is recognized that either the first list or the second list may be transformed, the illustration of FIG. 2 being for exemplary purposes only.

It is noted that the transformation is a monotonic transformation, as described in further detail below. This is also illustrated in FIG. 2, where the sequential order of the content items is not modified during this transformation such that the ranking of the content items are the same before and after the transformation. Rather, the transformation modifies the ranking parameters so that different lists are compatible for blending. With reference to nomenclature used above, if the transformation function f( ) is applied to scores s1( ), the resultant of function f(s1( )) is compatible with s2( ). Stated another way, if document d1 is from s1( ) data and document d2 is from s2( ) data and it is known that d1 is better then d2, the score of f1(s1(d1)) is greater than s2(d2).

In one embodiment, the transformation may include accessing a training data set associated with the first ranking parameters and assigning a relevance label to each of the content items of the first list based on the training data. With reference to FIG. 1, the training data set may be stored in the vertical scheme database 114.

In designing a blending transformation, the training data consists of a set of pairs {qᵢ}ᵢ₌₁^{Q}. In this system, the order for each individual ranking is preserved after blending, but this is not a requirement. Blending, while maintaining individual ranking may be similar to merge sorting, but merge sorting does not account for the vertical-specific ranking parameters. In the example of two rankings and considering qᵢ, the system then generates Equations 1 and 2.

R₁ⁱ={(d₁₁ⁱ,r₁₁ⁱ), (d₁₂ⁱ,r₁₂ⁱ), . . . ,(d_{1M}ⁱ,r_{1M}ⁱ)} Equation 1:

R₂ⁱ={(d₂₁ⁱ,r₂₁ⁱ), (d₂₂ⁱ,r₂₂ⁱ), . . . ,(d_{1N}ⁱ,r_{1N}ⁱ)} Equation 2:

In these equations, M and N are the numbers of items in the first and second set, respectively, and dⁱ₁ₘ and dⁱ₁ₙ are the items. Therefore, for Rⁱ₁ and Rⁱ₂, the system generates Equations 3 and 4.

r₁₁ⁱ≧r₁₂ⁱ≧ . . . ≧r_{1M}ⁱ Equation 3:

r₂₁ⁱ≧r₂₂ⁱ≧ . . . ≧r_{2N}ⁱ Equation 4:

Corresponding to Rⁱ₁, and Rⁱ₂ the combined ranking with totally M+N items is Equation 5.

Rⁱ={. . . , d₁ₘⁱ, . . . , d₂ₙⁱ, . . . } Equation 5:

Therefore, the order of items from either list is preserved in Rⁱ.

Accordingly, the system defines two subsets of {(m,n)|<=m<=M,m<=n<=N}: S⁺_{I} corresponds to cases where dⁱ₁ₘ is ranked above dⁱ₂ₙ and S⁻_{I} represents cases where dⁱ₁ₘ is ranked below d₂ₙ and define Equations 6 and 7.

$$\begin{matrix}{S}^{+} = {⋃}_{{q}_{1} ∈ Q} {S}_{i}^{+} & Equation 6 \\ {S}^{-} = {⋃}_{{q}_{1} ∈ Q} {S}_{-}^{+} & Equation 7\end{matrix}$$

The system provides for automatically learning to blend a transformation from the training data. This may be performed by applying a monotonically increase function f(.) to rⁱ₂ₙ, n=1, . . . , N in Rⁱ₂ so that the blending would be based on rⁱ₁ₘ and f(r¹₂ₙ). By doing so, the order of items from each individual ranking list are automatically preserved. f(.) is learning to maximally conform to the editorial blending rankings.

The transformation learning problem may be formalized as a quadratic problem noted in Equation 8.

$${min}_{f} {\sum }_{k = 1}^{K} {ζ}_{k}^{2} \qquad Equation 8$$

The factors of Equation of 8 are subject to the constraints of Equations 9, 10 and 11.

r₁ₘⁱ≧f(r₂ₙⁱ)−ζₖ(m,n)∈Sᵢ⁺ Equation 9:

f(r₂ₙⁱ)≧r₁ₘⁱ−ζₖ(m,n)∈Sᵢ⁻ Equation 10:

ζₖ≧0 Equation 11:

In these equations, K is the total number of items from both S⁺ᵢ and S⁻ᵢ where i=1, . . . , Q. In this system, upon the assumption that f(.) is linear and in the form of f(x)=ax+B, the above problem is noted in Equation 12.

$${min}_{α , β , {ζ}_{k}} {\sum }_{k = 1}^{K} {ζ}_{k}^{2} + {λ}_{1} {α}^{2} + {λ}_{2} {β}^{2} \qquad Equation 12$$

Equation 12 is subject to the constraints of Equations 13, 14 and 15, for i=1, . . . , Q.

r₁ₘⁱ≧αr₂ₙⁱ+β−ζₖ(m,n)∈Sᵢ⁺ Equation 13:

αr₂ₙⁱ+β≧r₁ₘⁱ−ζₖ(m,n)∈Sᵢ⁻ Equation 14:

ζₖ≧0,α≧0. Equation 15:

By solving the above quadratic problem, the system obtains an (a, B) for each ranking (the same (a, B) will be applied to all the queries). The system could also learn (a, B) for each query length (e.g. one word queries, two word queries, three word queries and four and plus word queries), or each type of queries for each ranking if query classification information is available.

In the case of paid inclusion blending where revenue impacts are also a concern, the system may first tune the range of a, B according to revenue impact or expected clicks and then include the range as additional constraints using the above equations.

With reference back to the flowchart of FIG. 3, the next step is merging the second list and the modified first list to generate a blended list, step 148. The merging step may be performed based on integrating the rankings between the different sets as the sets are now based on the same ranking parameters. In the example of FIG. 2, the ranking set 134 includes the result sets having different ranking values, the rankings being based on the ranking parameters for the first vertical, generating the vertical one prime result set. This merging operation may be performed using a merge sort operation, recognized by one skilled in the art. As the transformation function f( ) is monotonically increasing, the ordering/ranking for each individual vertical is preserved after the blending of step 148.

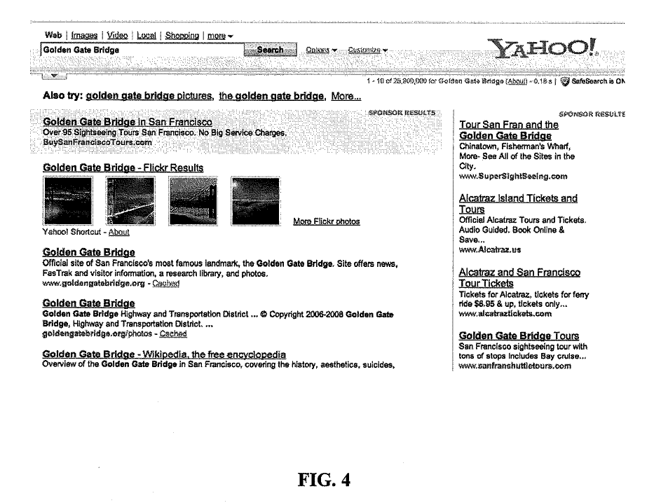

From the blended result sets, the blending device is then operative to generate the output display, step 150, where the generation may include providing the results for the search engine to thereupon apply any additional formatting or additional overlays for submission to the user 120. For example, the search results may be placed into a search results display page including different portions of the page for viewing by the user. For exemplary purposes only, FIG. 4 illustrates a sample screen shots that include search results as well as additional portions on the screen. The search results display of FIG. 4 may be generated based on multiple searches done through multiple verticals in accordance with the techniques described above.

Thereupon, with respect to FIG. 3, the method is complete. Additional embodiments are also recognized and within the scope of this invention. For example, the rank blending device is not limited to two verticals, but rather may receive and blend rankings from any number of verticals. For example, vertical-specific results may be transformed into the common vertical-specific formatting and then blending as described above.

The above-describe system and method may also be incorporated into larger operation systems, including the system of FIG. 1. For example, the transformation and blending may be in response to a user search request via a search engine. The system may include direct access to the different verticals in response to user requests, such as the user entering a search request in a search engine portal.

Utilizing the above-described method and system, users may be presented with an improved search result display of searching done across multiple verticals. The improved search result display is made possible based on the rank blending device normalizing the different verticals into a common ranking protocol.

FIGS. 1 through 4 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; electronic, electromagnetic, optical, acoustical, or other form of propagated signals (e.g., carrier waves, infrared signals, digital signals, etc.); or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments so fully reveals the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed is:

1. A method for blending rankings for an output display, the method comprising:
receiving a first list of content items having a first ranking determined by first ranking parameters, the first ranking providing for a sequential ordering of the content items of the first list;
receiving a second list of content items having a second ranking determined by second ranking parameters, the second ranking providing for a sequential ordering of the content items of the second list, wherein the first ranking of the first list is incompatible with the second ranking of the second list because the first ranking parameters are different from the second ranking parameters;
transforming the first list of content items to a modified first list, the order of the content items from the first list being maintained in the modified first list, wherein the transforming makes the first ranking of the modified first list compatible with the second ranking of the second list,
merging the second list and the modified first list to generate a blended list; and
generating the output display utilizing the blended list.

2. The method of claim 1 further comprising:
receiving the first list of content items from a first vertical; and
receiving the second list of content items from a second vertical, the first vertical being different from the second vertical.

3. The method of claim 1, wherein the blended list is generated using a merge sort operation.

4. The method of claim 1, wherein the content items include paid inclusion items.

5. The method of claim 1 further comprising:
prior to receiving the first list of content items and the second list of content items, receiving a search request such that the first list of content items and the second list of content items are based on the search request.

6. The method of claim 1 further comprising:
receiving a third list of content items having a third ranking determined by third ranking parameters, the third ranking providing for a sequential ordering of the content items of the third list, wherein the third ranking of the third list is incompatible with the first ranking of the first list and the second ranking of the second list because the third ranking parameters are different from the first ranking parameters and the second ranking parameters;
transforming the third list of content items to a modified third list, the order of the content items from the third list being maintained in the modified third list, wherein the transforming makes the third ranking of the modified third list compatible with the second ranking of the second list; and
merging the third list with the blended list.

7. A system for blending rankings for an output display, the system comprising:
a computer readable medium having executable instructions stored therein;
a processing device in communication with the computer readable medium, the processing device, in response to the executable instructions, operative to:
receive a first list of content items having a first ranking determined by first ranking parameters, the first ranking providing for a sequential ordering of the content items of the first list;
receive a second list of content items having a second ranking determined by second ranking parameters, the second ranking providing for a sequential ordering of the content items of the second list, wherein the first ranking of the first list is incompatible with the second ranking of the second list because the first ranking parameters are different from the second ranking parameters;
transform the first list of content items to a modified first list, the order of the content items from the first list being maintained in the modified first list, wherein the transforming makes the first ranking of the modified first list compatible with the second ranking of the second list,
merge the second list and the modified first list to generate a blended list; and
generate the output display utilizing the blended list.

8. The system of claim 7, the processing device further operative to:
receive the first list of content items from a first vertical; and
receive the second list of content items from a second vertical, the first vertical being different from the second vertical.

9. The system of claim 7, wherein generating the blended list uses a merge sort operation.

10. The system of claim 7, wherein the content items include paid inclusion items.

11. The system of claim 7, the processing device is further operative to:
prior to receiving the first list of content items and the second list of content items, receive a search request such that the first list of content items and the second list of content items are based on the search request.

12. The system of claim 7, the processing device is further operative to:
receive a third list of content items having a third ranking determined by third ranking parameters, the third ranking providing for a sequential ordering of the content items of the third list, wherein the third ranking of the third list is incompatible with the first ranking of the first list and the second ranking of the second list because the third ranking parameters are different from the first ranking parameters and the second ranking parameters;
transform the third list of content items to a modified third list, the order of the content items from the third list being maintained in the modified third list, wherein the transforming makes the third ranking of the modified third list compatible with the second ranking of the second list; and
merge the third list with the blended list.

13. Computer readable media comprising program code that when executed by a programmable processor causes execution of a method for blending user rankings for an output display, the computer readable media comprising:
program code for receiving a first list of content items having a first ranking determined by first ranking parameters, the first ranking providing for a sequential ordering of the content items of the first list;
program code for receiving a second list of content items having a second ranking determined by second ranking parameters, the second ranking providing for a sequential ordering of the content items of the second list, wherein the first ranking of the first list is incompatible with the second ranking of the second list because the first ranking parameters are different from the second ranking parameters;
program code for transforming the first list of content items to a modified first list, the order of the content items from the first list being maintained in the modified first list, wherein the transforming makes the first ranking of the modified first list compatible with the second ranking of the second list,
program code for merging the second list and the modified first list to generate a blended list; and
program code for generating the output display utilizing the blended list.

14. The computer readable medium of claim 13 further comprising:
program code for receiving the first list of content items from a first vertical; and
program code for receiving the second list of content items from a second vertical, the first vertical being different from the second vertical.

15. The computer readable medium of claim 13, wherein generating the blended uses a merge sort operation.

16. The compute readable medium of claim 13, wherein the content items include paid inclusion items.

17. The computer readable medium of claim 13 further comprising:
program code for receiving a search request such that the first list of content items and the second list of content items are based on the search request.

18. The compute readable medium of claim 13 further comprising:
program code for receiving a third list of content items having a third ranking determined by third ranking parameters, the third ranking providing for a sequential ordering of the content items of the third list, wherein the third ranking of the third list is incompatible with the first ranking of the first list and the second ranking of the second list because the third ranking parameters are different from the first ranking parameters and the second ranking parameters;
program code for transforming the third list of content items to a modified third list, the order of the content items from the third list being maintained in the modified third list, wherein the transforming makes the third ranking of the modified third list compatible with the second ranking of the second list; and
program code for merging the third list with the blended list.
